(19) United States
(12) Patent Application Publication
(10) Pub. No.: US 2008/0286182 A1
(43) Pub. Date: Nov. 20, 2008

(54) Combined Leaching Process

(75) Inventors: Renato de Souza Costa, Minas Gerais (BR); Flavia Dutra Mendes, Minas Gerais (BR)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: COMPANHIA VALE DO RIO DOCE, Santa Luzia, MG (BR)

(21) Appl. No.: 12/093,257

(22) PCT Filed: Feb. 7, 2006
(86) PCT No.: PCT/BR2006/000017

§ 371 Date: May 9, 2008

(30) Foreign Application Priority Data
Nov. 10, 2005 (BR) PI 0505544-0

(51) Int. Cl. B01D 11/02; C01F 7/76

(52) U.S. Cl. 423/132

(57) ABSTRACT

THE COMBINED LEACHING PROCESS comprises a dissolution process of the soluble constituents of an ore by means of the combined execution of two or more serial leaching phases with the first phase comprising atmospheric leaching (AL) and the second one pressure leaching (HPAL). This combined process takes place when the intermediate size fraction (0.075-0.5 mm) is submitted to atmospheric leaching (AL), ensuing an effluent with a high concentration of dissolved iron and aluminum as well as high residual acidity. This said effluent is fed in the following acid pressure leaching (HPAL) phase of the fine size fraction (<0.075 mm) and at reusing free acidity, regenerating the sulfuric acid through iron and aluminum precipitation in a hydrolysis reaction, and bringing forth a considerable reduction in the addition of sulfuric acid.

The purpose of this report is to describe a combined leaching process, that is, a dissolution process of soluble constituents of a given nickel ore or concentrate by the action of acids such as, but not limiting to, base, and most particularly the combined execution of two or more serial leaching phases thus making it possible to decrease the consumption of the reagent used for leaching, as this prevents leaching operations from being cost ineffective.

As expert technicians know very well, lateritic ores can be treated by means of hydrometallurgical route where sulfuric leaching is the traditional process used for extracting both nickel and cobalt. This ore is Fe-rich, also contains Al, Mn and Si and the percentage of Ni ranges from 0.8% to 1.4% and Co varies from 0.05% to 0.2%. Depending of ore grain size, two types of leaching can be used, namely, pressure acid leaching (HPAL) and atmospheric leaching (Al).

Pressure acid leaching (HPAL) occurs at high temperatures in acid corrosion resistant titanium autoclaves. In this case the ore to be fed shall have fine grain size and an high Ni grade, thus making it necessary the use of such process. Processing the ore by screening and classification can enrich nickel level by approximately 100%. In operational temperature balance vapor pressure ranges from 33-55 atm, iron and aluminum (trivalent form) are initially dissolved, followed by a precipitation in the autoclave in the form of hematite and alunite, respectively, with the ensuing generation of acid.

Atmospheric leaching (AL) is carried out at lower temperatures than acid pressure leaching and under atmospheric pressure. Intermediate ore size fraction has a lower Ni grade as compared to fine fraction grades. Therefore, due to economical reasons the use of pressure leaching (HPAL) is not recommended. On the other hand, atmospheric leaching (AL) may be suitable since it requires fewer investments but the consumption of acid is higher with greater iron and aluminum solubilization.

Particularly in the case of atmospheric leaching (AL), acid consumption depends heavily on the presence of consuming elements such as iron, aluminum and magnesium in the ore, which are fairly dissolved and remain in solution in the form of sulphates. Therefore, the higher the grade of such elements in the ore, the higher the consumption of acid for the operation.

Although being largely used, independent teaching techniques can be cost ineffective mainly in the case of atmospheric leaching (AL) by virtue of increased sulfuric acid consumption as it leaches preferably iron, aluminum, magnesium, manganese and nickel. In other words, for Ni extractions higher than 90% it requires the addition of a higher quantity of acid to solubilize remaining consuming elements. Whatever leaching process is used, acid consumption can become a crucial variable that makes the process unviable.

Another inconvenient as far as leaching processes are concerned is the liquor derived from leaching, which contains a number of solubilized metals (Fe, Mg, Al, Mn), and increases both complexity and cost of a late purifying phase.

This patent request proposes the use of a combined leaching where the extraction process is carried out in two or more serial phases aimed at providing nickel recovery of the intermediate size fraction at an early phase of atmospheric leaching, where a significant portion of nickel is distributed with a mean grade placed around 1% Ni, as well as to bring the free acidity generated during atmospheric leaching (Al) to the following pressure acid leaching phase (HPAL).

Another purpose of this invention is the reduction in acid consumption during the pressure acid leaching (AHPAL) phase given that the hydrolysis process occurs in the autoclave with the advantageous precipitation of iron and aluminum in the form of hematite and alunite, as well as acid regeneration made available through operational conditions. Iron and aluminum, dissolved during the first leaching phase (AL) in the form of sulphates in solution are fed into the second leaching phase (HPAL) and are considered the main source for acid regeneration through hydrolysis reaction. This procedure has a direct impact on acid reduction, which is added during the pressure acid leaching phase in autoclave, with no interference in the results of the process.

These invention's objectives and advantages, among others, can be achieved using two or more serial leaching phases.

This invention is further discussed herein based on the attached drawings in which:

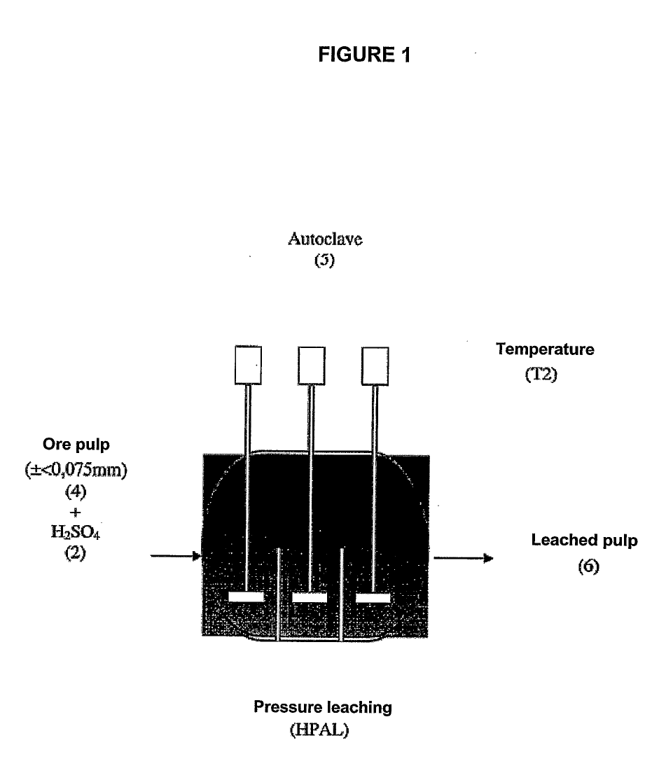

FIG. 1 shows a schematic pressure leaching (HPAL) drawing;

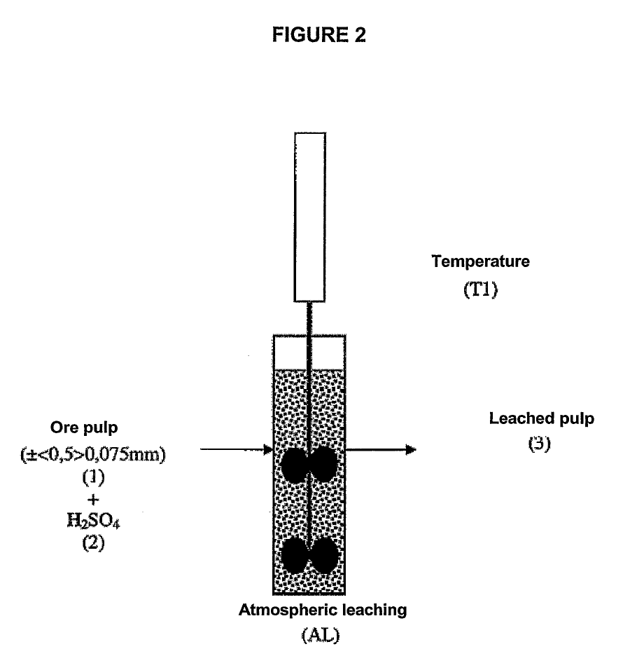

FIG. 2 shows a schematic atmospheric leaching (AL) drawing;

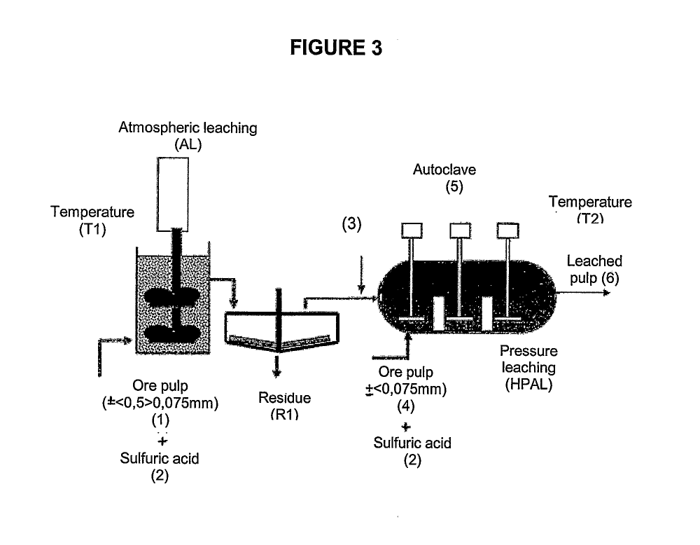

FIG. 3 shows a combined leaching schematic drawing and

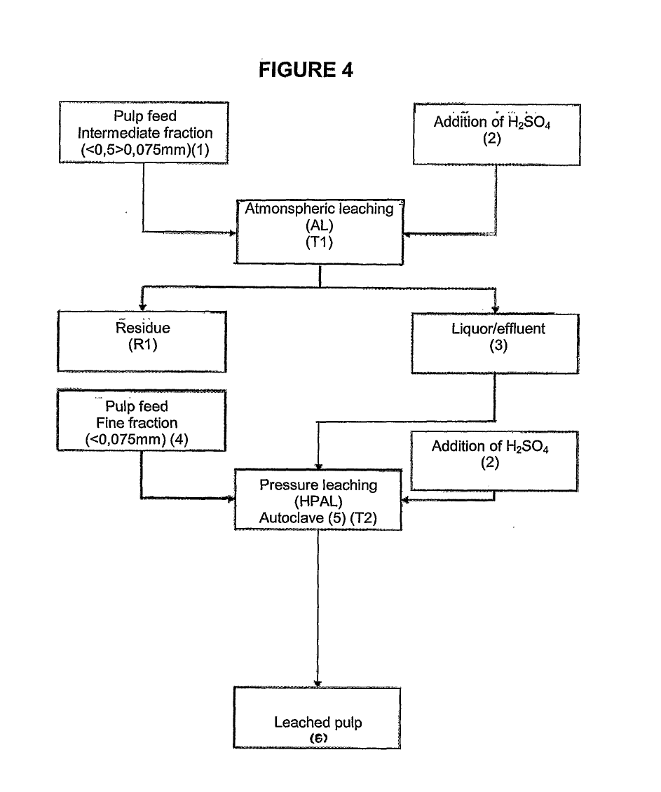

FIG. 4 shows a combined leaching process flowchart.

As shown in these figures, the combined leaching process, which is the object of this present invention, comprises the execution of serial leaching phases. Firstly, the intermediate fraction (±<0.5>0.075 mm) (1) is submitted to atmospheric leaching (AL). During this phase, there is a high consumption of sulfuric acid (2) because of the solubilization of consuming elements such as Fe, Al and Mg, resulting in an effluent (3) with a high concentration of dissolved iron and aluminum and high residual acidity. This effluent (3), in its present form, is fed into the next pressure acid leaching (HPAL) of the fine size fraction (±<0.075 mm) (4). The purpose of this approach is to reduce the quantity of sulfuric acid (2) to be added

As shown in FIG. 1, pressure leaching (HPAL) occurs when the effluent from the first leaching (3) and the ore and sulfuric acid (2) fine fraction pulp (±<0.075 mm) (4) feed the autoclave (5) with an approximate proportion of 34% solids. Leaching takes place at high temperatures (T2) (±250° C.), with agitation of 500 rpm for 1.25 hours. Gross sulfuric acid consumption (2) depends on the consuming elements grade in the ore and extraction is greater than 95% Ni. Dissolved iron and aluminum are submitted to hydrolysis in the autoclave (5) and are precipitated in the form of hematite and ghoetite, respectively, regenerating sulfuric acid (2).

As shown in FIG. 2, atmospheric leaching (AL) takes place when the ore intermediate size fraction pulp (±<0.5 mm>0.075 mm) (1), together with sulfuric acid (2) is leached at temperatures (T1) of approximately 95° C. with 33% solids with agitation of 130 rpm for 6 hours. Ni extraction is greater than 90%, but, sulfuric acid consumption (2) is very high because of high iron and aluminum dissolution in solution.

As shown in FIG. 3 and flowchart 4, combined serial leaching process comprises atmospheric leaching (AL) followed by pressure leaching (HPAL). The intermediate size fraction pulp (±<0.5>0.075 mm) (1) is submitted to atmospheric leaching with sulfuric acid (2), at a temperature (T1) of 95° C., agitation of 130 rpm and 33% solids for 6 hours. The effluent (3) from the first leaching (AL), together with both sulfuric acid (2) and fine fraction (±<0.075 mm) (4) feed the autoclave (5) for pressure leaching (HPAL) at a temperature of (T2) 250° C., agitation of 500 rpm, pressure at 650 psi and 34% solids for 75 minutes.

The effluent (3) from atmospheric leaching (AL) shows free acidity that is used in pressure leaching (HPAL). Iron sulphate (III) and aluminum (III) hydrolysis reaction in the autoclave cause Fe precipitation in the form of hematite and Al in the form of alunite, regenerating sulfuric acid (2). Leaching mechanisms during the atmospheric phase (AL) and iron and aluminum further precipitation mechanisms during the pressure phase (HPAL) can be described as follows:

Ghoetite dissolution in atmospheric leaching (AL)

2FeOOH+3H₂SO₄→Fe₂(SO₄)₃+4H₂O

Hematite formation and sulfuric acid generation (2) take place during pressure leaching (HPAL) by the hydrolysis process.

Fe₂(SO₄)₃+3H₂O X Fe₂O₃(s)+3H₂SO₄

Bhoemite dissolution in atmospheric leaching (AL)

2AlOOH+3H₂SO₄→Al₂(SO₄)₃+4H₂O

Alunite formation and sulfuric acid generation take place during pressure leaching (HPAL) by hydrolysis process.

3AL₂(SO₄)₃+14H₂O→2(H₃O)Al₃(SO₄)₂(OH)₆(s)+5H₂SO₄

Because free acidity is reused and sulfuric acid is regenerated (2) from iron sulphate (III) and aluminum (III) in solution, the sulfuric acid volume (2) to be added to pressure leaching (HPAL) was reduced, being equivalent to an average of only 60% of gross sulfuric acid consumption (2).

In other words, there is a considerable reduction of the order of 40% in the added sulfuric acid (2) with combined leaching, without prejudice to nickel extraction. This reduction in the addition of sulfuric acid (2) has a direct impact on the economical feasibility of a given project. The use of the effluent solution (3) from the atmospheric leaching (AL), with high free acidity and high iron and aluminum concentration in solution, in the pressure leaching (HPAL), is responsible for a reduction of 40% in the addition of sulfuric acid (2) in this phase by virtue of the hydrolysis process in which dissolved iron and aluminum can precipitate and regenerate sulfuric acid (2).

In this request we have referred, but not limiting to, certain operational conditions such as temperature, solid %, time and agitation. We should point out, therefore, that these conditions can vary during each serial leaching phase, without any prejudice to the process final results.

It should pointed out, though, that the preferable operational process herein described and illustrated is liable to feasible alterations without any deviation from the scope of the present invention.

What is claimed is:

1. A COMBINED LEACHING PROCESS, comprising a dissolution process of soluble constituents by a combined execution of two or more serial leaching phases with a first phase comprising atmospheric leaching (AL) and a second phase comprising pressure leaching (HPAL), wherein the combined process takes place when an intermediate size fraction (<0.5>0.075 mm) is submitted to the atmospheric leaching (AL) ensuing an effluent with high concentration of dissolved iron and aluminum as well as high residual acidity, wherein the effluent is fed during the following pressure acid leaching (HPAL) of a fine fraction (<0.075 mm).

2. THE COMBINED LEACHING PROCESS according to claim 1, wherein in the first combined leaching phase the intermediate size fraction (<0.5 mm>0.075 mm) of the ore is placed together with a sulfuric acid solution and is submitted to the atmospheric leaching (AL) at a temperature of 95° C. with 33% solids for an agitation of 130 rpm for 6 hours, during which Ni extraction is greater than 90%, where a high dissolution of both iron and aluminum also occurs, which remain in the solution.

3. THE COMBINED LEACHING PROCESS according to claim 1, wherein during the second combined leaching phase the effluent of the first leaching (AL), together with sulfuric acid and with fine fraction pulp (<0.075 mm) feed an autoclave for the realization of the pressure leaching (HPAL) at a temperature of 250° C., with agitation of 500 rpm, pressure of 650 psi and with 34% solids for 75 minutes.

4. THE COMBINED LEACHING PROCESS according to claim 3, wherein the effluent from the atmospheric leaching (AL) shows free acidity and is reused in the pressure leaching (HPAL) and wherein iron (III) and aluminum (III) sulphate hydrolysis reaction takes place causing Fe precipitation in the form of hematite and Al in the form of alunite, thus regenerating sulfuric acid.

5. THE COMBINED LEACHING PROCESS according to claim 1, wherein the reuse of the effluent's free acidity and the regeneration of sulfuric acid from iron sulphate (III) and aluminum (III), with the resulting reduction of sulfuric acid volume to be added to the pressure leaching (HPAL), being equivalent to an average of only 60% of gross sulfuric acid consumption.

6. THE COMBINED LEACHING PROCESS according to claim 1, wherein the use of the effluent solution from the atmospheric leaching (AL), showing high free acidity and high iron and aluminum concentration in solution, feeds the pressure leaching (HPAL) bringing forth a reduction of 40% in the addition of sulfuric acid because of a hydrolysis process in which dissolved iron and aluminum precipitate and regenerate the sulfuric acid.

7. THE COMBINED LEACHING PROCESS according to claim 6, wherein in the combined leaching, there is a considerable saving of added sulfuric acid, of about 40%, without prejudice to nickel extraction with direct impact on the economical feasibility of the project.
